(19) United States
(12) Patent Application Publication
(10) Pub. No.: US 2026/0213987 A1
(43) Pub. Date: Jul. 23, 2026

(54) JOINT COMMUNICATIONS AND RADIO FREQUENCY SENSING BASED ON CELL-SPECIFIC AND WIDEBAND REFERENCE SIGNALS

(71) Applicant: QUALCOMM Incorporated, San Diego, CA (US)

(72) Inventors: Yuwei REN, Beijing (CN); Weimin DUAN, San Diego, CA (US); Hyojin LEE, San Diego, CA (US); Huilin XU, Temecula, CA (US)

(21) Appl. No.: 19/138,571

(22) PCT Filed: Mar. 7, 2023
(86) PCT No.: PCT/CN2023/079990

§ 371 Date: Jun. 12, 2025

(51) Int. Cl. H04L 27/26; H04B 7/06

(52) U.S. Cl. CPC H04L 27/261; H04B 7/06968

(57) ABSTRACT

In an aspect, a UE may obtain an indication of a pattern of a set of cell-specific reference signals (CRSs). The UE may receive at least one CRS in the set of CRSs based on the pattern of the set of CRSs. The UE may perform, based on the at least one CRS, a set of measurements for a radio frequency (RF) sensing session. In another aspect, a network node may provide, for a user equipment (UE), an indication of a pattern of a set of CRSs. The network node may provide, for the UE, at least one CRS in the set of CRSs based on the pattern of the set of CRSs. The network node may receive, from the first UE based on the at least one CRS, a sensing measurement report comprising a first set of measurements for an RF sensing session.

### TECHNICAL FIELD

The present disclosure relates generally to positioning systems, and more particularly, to positioning systems involving cell-specific reference signals (CRSs) and wideband reference signals.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long-Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first user equipment (UE) are provided. The apparatus may include memory and at least one processor coupled to the memory. The at least one processor, based at least in part on information stored in the memory may be configured to obtain an indication of a pattern of a set of CRSs, receive at least one CRS in the set of CRSs based on the pattern of the set of CRSs, and perform, based on the at least one CRS, a set of measurements for a radio frequency (RF) sensing session.

In another aspect of the disclosure, a method, a computer-readable medium, and an apparatus at a first network node are provided. The apparatus may include memory and at least one processor coupled to the memory. The at least one processor, based at least in part on information stored in the memory may be configured to provide, for a first UE, an indication of a pattern of a set of CRSs, provide, for the first UE, at least one CRS in the set of CRSs based on the pattern of the set of CRSs, and receive, from the first UE based on the at least one CRS, a sensing measurement report including a first set of measurements for an RF sensing session.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 depicts a diagram illustrating a plurality of physical resource blocks in a fully frequency-domain staggered pattern.

FIG. 6 depicts a table illustrating different configurations for positioning reference signal-based sensing.

FIG. 7 depicts a table illustrating different configurations for synchronization signal block (SSB)-based sensing.

FIG. 8 depicts a diagram of an example SSB in accordance with various aspects of the present disclosure.

FIG. 9 depicts a diagram illustrating a comb-4 structure.

FIG. 10 depicts a table illustrating different configurations for tracking reference signal-based sensing.

FIG. 11A depicts a diagram that illustrates new radio (NR) mini-slots that are situated between always on long-term evolution (LTE) CRSs.

FIG. 11B depicts a diagram that illustrates CRS symbol level rate matching.

FIG. 11C depicts a diagram that illustrates CRS resource element level rate matching.

FIG. 11D depicts NR resources that utilize an LTE multimedia broadcast single frequency network.

FIG. 12A depicts a diagram that illustrates joint CRS and NR reference signal-based sensing in accordance with various aspects of the present disclosure.

FIG. 12B depicts a diagram that illustrates LTE CRS-based sensing for a dynamic spectrum sharing UE in accordance with various aspects of the present disclosure.

FIG. 13 is a call flow diagram illustrating a method of wireless communication in accordance with various aspects of this present disclosure.

FIG. 14 is a flowchart illustrating methods of wireless communication, in accordance with various aspects of the present disclosure.

FIG. 15 is a flowchart illustrating methods of wireless communication, in accordance with various aspects of the present disclosure.

FIG. 16 is a flowchart illustrating methods of wireless communication, in accordance with various aspects of the present disclosure.

FIG. 17 is a flowchart illustrating methods of wireless communication, in accordance with various aspects of the present disclosure.

FIG. 18 is a diagram illustrating an example of a hardware implementation for an example apparatus and/or network entity.

FIG. 19 is a diagram illustrating an example of a hardware implementation for an example network entity.

FIG. 20 is a diagram illustrating an example of a hardware implementation for an example network entity.

### DETAILED DESCRIPTION

Various aspects relate generally to positioning systems. Some aspects more specifically relate to joint CRS and NR reference signal measurements for RF sensing. In some examples, a network node may provide, to a UE (e.g., an NR UE or a dynamic spectrum sharing (DSS) UE), an indication of a pattern of a set of CRSs (e.g., always-on LTE CRSs). The network node may provide one or more CRSs to the UE based on the pattern. The network node may also provide, to the UE, one or more wideband reference signals. The UE may perform a set of measurements for an RF sensing session based on the CRS(s) and/or wideband reference signal(s).

Particular aspects of the subject matter described in this disclosure can be implemented to realize one or more of the following potential advantages. In some examples, NR UEs or DSS UEs may be incapable of high-resolution target speed estimation and high accuracy Doppler estimation when performing measurements using just wideband reference signals. By providing CRSs to a NR UE or a DSS UE, along with the wideband reference signals, the NR UE or the DSS UE may perform high-resolution target speed estimation and high accuracy Doppler estimation via measurements based on the CRSs and the wideband reference signals. By doing so, the target speed and/or location of the target may be more accurately estimated.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

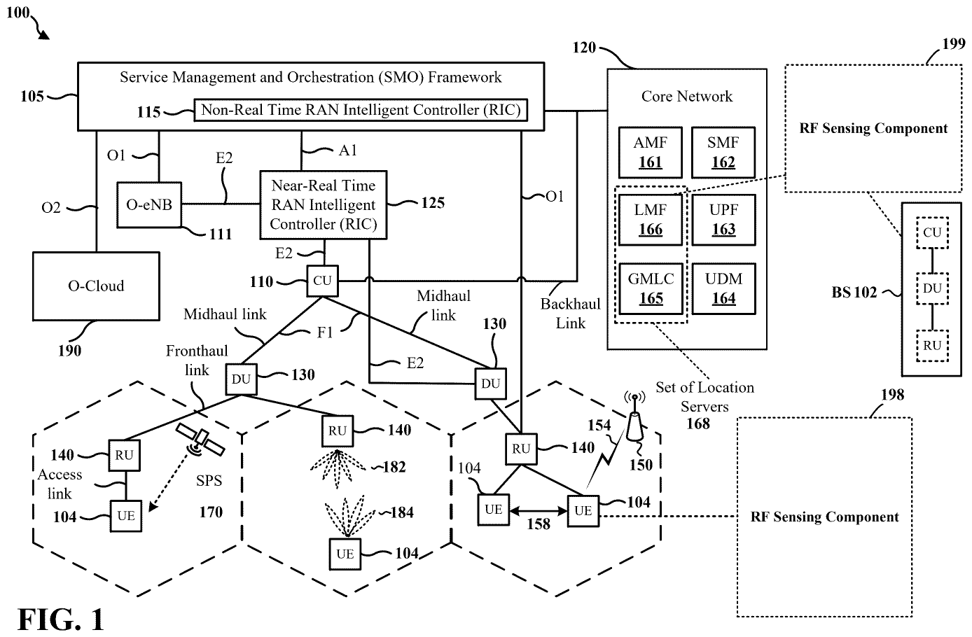

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. The LMF 166 may also coordinate RF sensing sessions for a target entity, for example, by configuring nodes (e.g., TRPs or UEs) for the RF sensing sessions. The LMF 166 may also receive measurements and/or additional information from a node and determine a sensing result (e.g., a position of the target entity) based on the measurements and/or additional information. It is noted that the RF sensing session functionality described herein with reference to the LMF 166 may be implemented in an entity separate from the LMF 166, such as a sensing management function (SnMF). The SnMF may be included in the core network 120 or may be located at the base station 102. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an RF sensing component 198 that may be configured to obtain an indication of a pattern of a set of CRSs, receive at least one CRS in the set of CRSs based on the pattern of the set of CRSs, and perform, based on the at least one CRS, a set of measurements for an RF sensing session. In certain aspects, the base station 102 may have an RF sensing component 199 that may be configured to provide, for a first UE, an indication of a pattern of a set of CRSs, provide, for the first UE, at least one CRS in the set of CRSs based on the pattern of the set of CRSs, and receive, from the first UE based on the at least one CRS, a sensing measurement report including a first set of measurements for an RF sensing session.

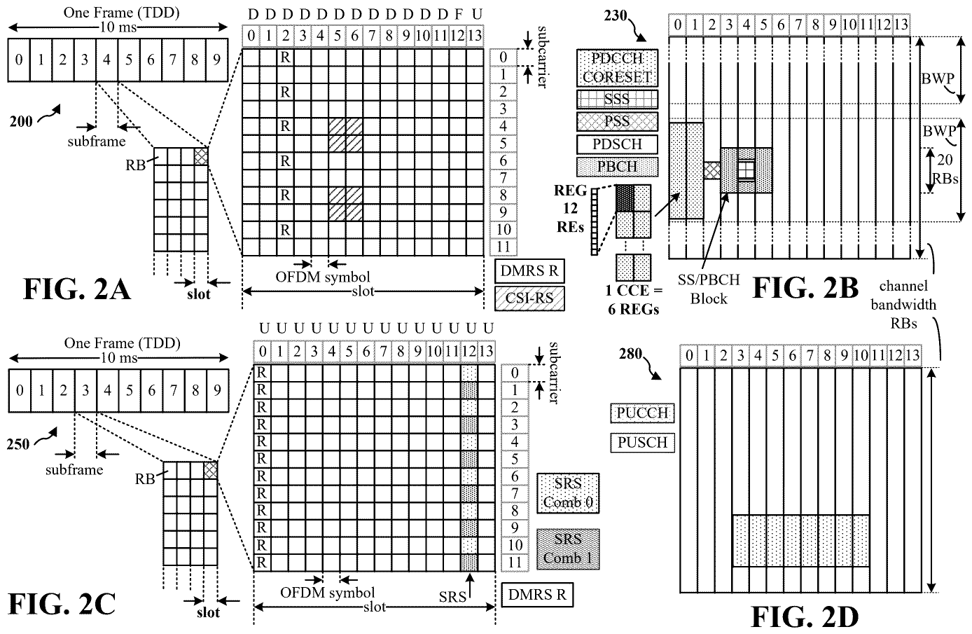

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

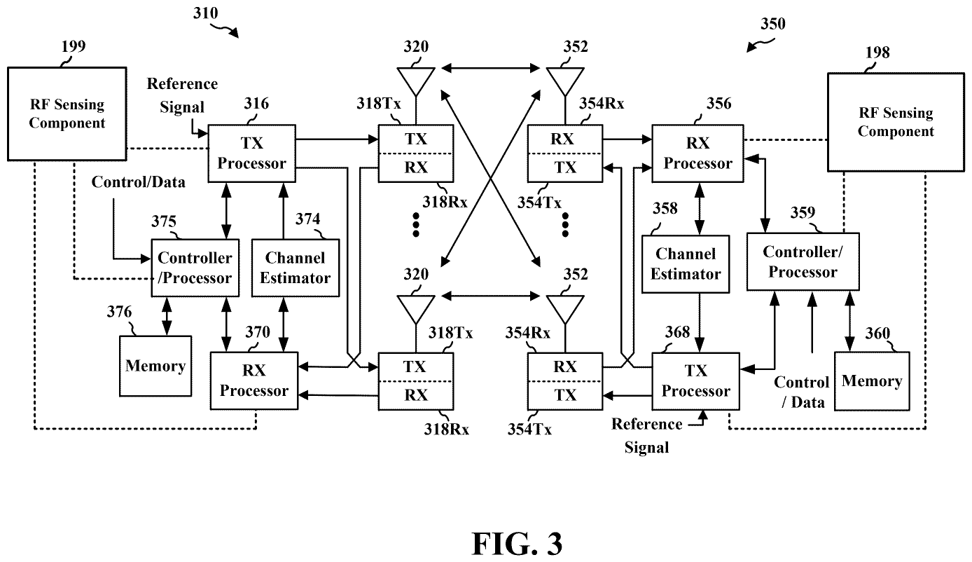

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RF sensing component 198 of FIG. 1.

<w/BS Claims> At least one of the TX processor 316, the RX processor 370, and the controller/processor 375 may be configured to perform aspects in connection with the RF sensing component 199 of FIG. 1.

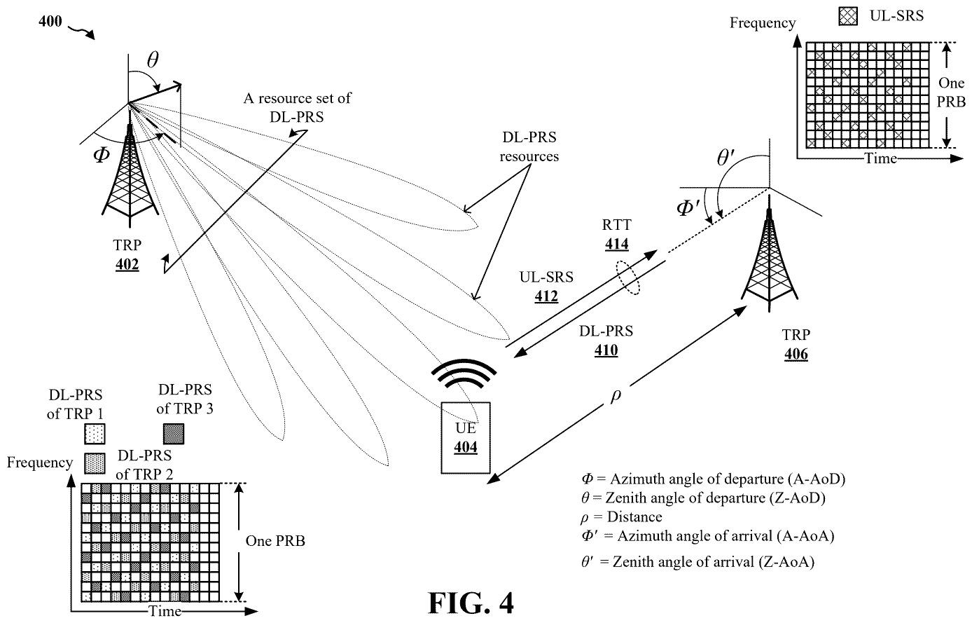

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on |T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a UE, an access point (AP), etc.) may also be configured to include sensing capabilities, where the wireless device may be able to sense (e.g., detect and/or track) one or more objects or target entities of an area or in an environment based on radio frequencies. An environment may refer to a particular geographical area or place, especially as affected by human activity, or the circumstances, objects, or conditions by which one is surrounded. For example, a wireless device may include a radar capability (which may be referred to as “RF sensing” and/or “cellular-based RF sensing), where the wireless device may transmit reference signals (e.g., radar reference signals (RRSs)) and measure the reference signals reflected from one or more objects (e.g., structures, walls, living objects, and/or things in an environment, etc.). Based on the measurement, the wireless device may determine or estimate a distance between the wireless device and the one or more objects and/or obtain environmental information associated with its surrounding. In another example, a first wireless device may receive signals transmitted from a second wireless device, where the first wireless device may determine or estimate a distance between the first wireless device and the second wireless device based on the received signals. For example, a tracking device (e.g., a Bluetooth tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device,” a “sensing node,” or a “sensing entity.” For example, a sensing device may be a UE, an AP device (e.g., a Wi-Fi router), a base station, a component of the base station, a TRP, a device capable of performing radar functions, etc. Furthermore, a target entity may be any object (e.g., a person, a vehicle, a UE, etc.) for which a positioning or sensing session is performed, for example, to determine a location thereof, a velocity thereof, a heading thereof, a physiological characteristic thereof, etc. In addition, a device/apparatus that is capable of transmitting signals to a sensing device for the sensing device to determine the location or the relative distance of the device/apparatus may be referred to as a “tracking device,” a “tracker,” or a “tag.”

For purposes of the present disclosure, a positioning session may be referred to the transmitting, the receiving, and the measuring of reference signals for the purposes of determining a positioning result or state (e.g., a location, a heading, a velocity, etc.) of a target entity. An RF sensing session may refer to the transmitting, the receiving, and the measuring of reference signals for the purposes of determining a sensing result or state of an environment in which the target entity is included (e.g., a change in the environment), at least one physiological characteristic of a target entity, a location of the target entity, a velocity of the target entity, a heading of the target entity, etc.

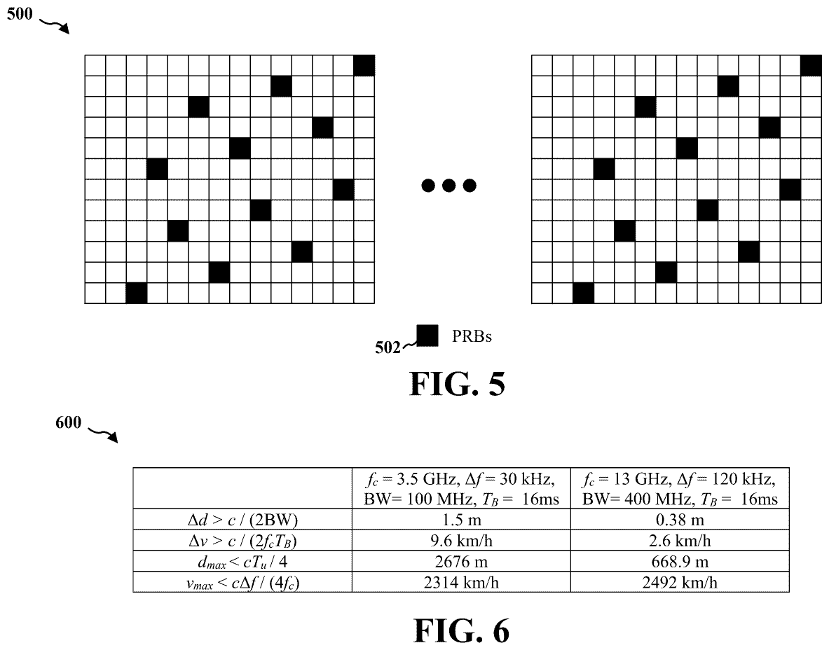

DL-PRSs may be utilized for RF sensing purposes. A DL-PRS configuration may be flexible in both the time and frequency domain. The PRS bandwidth (BW) may be between 24 PRBs and 272 PRBs and may utilize a fully frequency-domain staggered pattern. For example, FIG. 5 depicts a diagram 500 illustrating a plurality of PRBs 502 in a fully frequency-domain staggered pattern. A DL-PRS configuration may have a configurable resource repetition (e.g., N=1, 2, 4, 6, 8, 16, 32, etc.) and a configurable time gap (G=1, 2, 4, 8, 16, 32, etc.). A single PRS resource may span up to 32×32 slots (T_{B}=16 ms with N=32, G=4 in case of 120 kHz SCS, where T_{B} corresponds to the total length of time for a single PRS resource). Multiple positioning frequency layers may be used for different sensing purposes. For example, one positioning frequency layer (e.g., a wide BW/short duration layer) may be used for range estimation, while another positioning frequency layer (e.g., a narrow BW/long duration layer) may be used for velocity estimation.

PRS design for sensing may be improved. For example, phase continuity between multiple PRS transmissions may be guaranteed for velocity estimation. Multiple ports may be utilized to support MIMO radar sensing for better AoA estimation.

FIG. 6 depicts a table 600 illustrating different configurations for PRS-based sensing. As shown in FIG. 6, a first configuration (represented by the first column) may utilize a carrier frequency (f_{c}) of 3.5 GHZ, a frequency granularity (Δf) of 30 kHz, a bandwidth of 100 MHz, and a T_{B} of 16 ms. A second configuration (represented by the second column) may utilize a carrier frequency (f_{c}) of 13 GHz, a frequency granularity (Δf) of 120 kHz, a bandwidth of 400 MHz, and a T_{B} of 16 ms. As shown in FIG. 6, the increase in the carrier frequency (f_{c}), the frequency granularity (Δf) and bandwidth results in an improvement in range (or distance) estimation granularity (Δ_{d}) (i.e., from 1.5 m to 0.38 m), and an improvement in velocity estimation granularity (Δᵥ) (i.e., from 9.6 km/h to 2.6 km/h). However, the maximum range (dₘₐₓ) that can be detected via sensing decreases (i.e., from 2676 m to 668.9 m). The maximum velocity (vₘₐₓ) that can be detected slightly improves (i.e., from 2314 km/h to 2492 km/h). It is noted that UL SRS-based positioning may provide the same sensing capability table with a flexible time-frequency resource configuration. However, uplink radar sensing may have additional challenges on phase continuity and uplink power limitation.

SSBs may also be utilized for RF sensing purposes. A single SSB may include 20 RBs in 4 consecutive OFDM symbols. An SSB may be used for object detection before the accurate range/velocity estimation using other reference signals. The range resolution may be greater than 5 m with 120 kHz SCS. Velocity estimation may be challenging with a single SSB because the velocity estimation granularity (Av) may be greater than 1000 km/h.

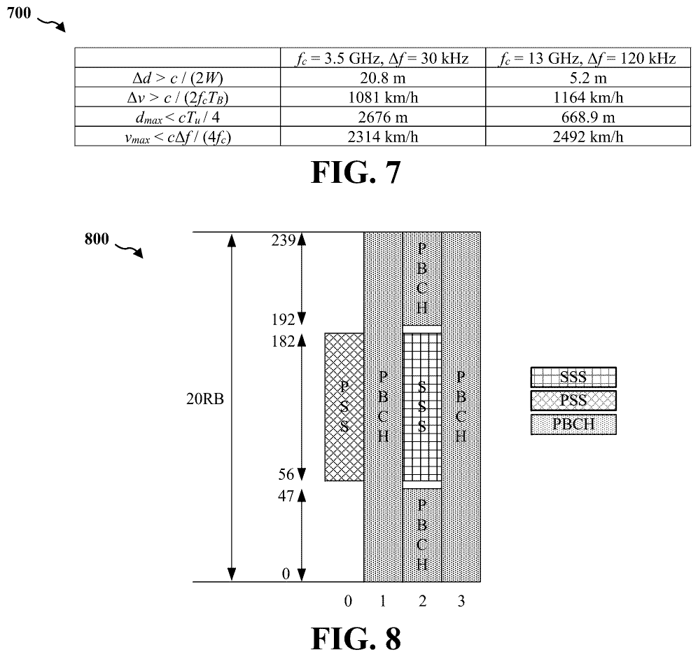

FIG. 7 depicts a table 700 illustrating different configurations for SSB-based sensing. As shown in FIG. 7, a first configuration (represented by the first column) may utilize a carrier frequency (f_{c}) of 3.5 GHz and a frequency granularity (Δf) of 30 kHz. A second configuration (represented by the second column) may utilize a carrier frequency (f_{c}) of 13 GHz and a frequency granularity (Δf) of 120 kHz. As shown in FIG. 7, the increase in the carrier frequency (f_{c}) and the frequency granularity (Δf) results in an improvement in range (or distance) estimation granularity (Δd) (i.e., from 20.8 m to 5.2 m). However, the velocity estimation granularity (Δv) is slightly impaired (i.e., from 1081 km/h to 1164 km/h). The maximum range (dₘₐₓ) that can be detected via sensing is also decreased (i.e., from 2676 m to 668.9 m). The maximum velocity (vₘₐₓ) that can be detected slightly improves (i.e., from 2314 km/h to 2492 km/h).

FIG. 8 depicts a diagram 800 of an example SSB in accordance with various aspects of the present disclosure. As shown in FIG. 8, a PSS may be within symbol 2 of particular subframes of a frame. An SSS may be within symbol 4 of particular subframes of a frame. The PBCH may be logically grouped with the PSS and SSS to form the SSB). As also shown in FIG. 8, the SSB may include 20 RBs in four consecutive OFDM symbols (0, 1, 2, and 3) and may consist of 240 subcarriers (0-239).

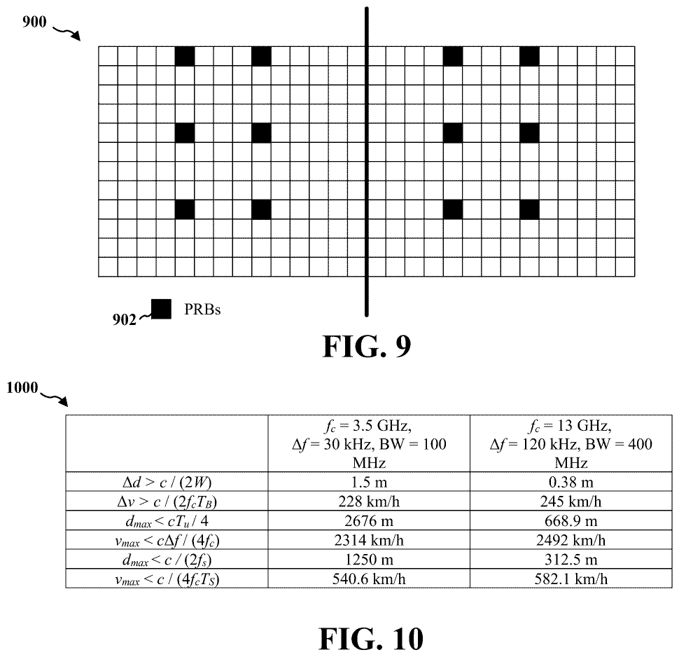

Tracking reference signals (TRSs) (or CSI-RSs) may also be utilized for RF sensing purposes. For example, full band TRSs with a rho value of three may support a similar range estimation capability to PRS-based RF sensing. A comb-4 structure (where a resource is allocated in every fourth subcarrier) without staggering may cause an aliasing problem from range estimation. For example, FIG. 9 depicts a diagram 900 illustrating a comb-4 structure. As shown in FIG. 9, a reference signal (RS) 902 is allocated in every fourth subcarrier.

An up to two-slot TRS pattern may be supported with a separation of four symbols. The velocity resolution may not be enough with a velocity estimation granularity of greater than 200 km/h due to the limited time span. For better velocity estimation, a longer TRS repetition and phase continuity may be introduced.

FIG. 10 depicts a table 1000 illustrating different configurations for TRS-based sensing. As shown in FIG. 10, a first configuration (represented by the first column) may utilize a carrier frequency (f_{c}) of 3.5 GHZ, a frequency granularity (Δf) of 30 kHz, and a bandwidth of 100 MHz. A second configuration (represented by the second column) may utilize a carrier frequency (f_{c}) of 13 GHZ, a frequency granularity (Δf) of 120 kHz, and a bandwidth of 400 MHz. As shown in FIG. 10, the increase in the carrier frequency (f_{c}), the frequency granularity (Δf), and the bandwidth results in an improvement in range (or distance) estimation granularity (Δd) (i.e., from 1.5 m to 0.38 m). However, the velocity estimation granularity (Δv) is slightly impaired (i.e., from 228 km/h to 245 km/h). The maximum range (dₘₐₓ) that can be detected via sensing is also decreased (i.e., from 2676 m to 668.9 m). The maximum velocity (vₘₐₓ) that can be detected slightly improves (i.e., from 2314 km/h to 2492 km/h). As demonstrated above, a PRS configuration may be flexible to be reused for radar sensing and may be improved. For example, phase continuity between multiple PRS transmissions may not be guaranteed for velocity estimation. Multiple ports may be utilized to support MIMO radar sensing. SSB could be used for target detection before accurate range and velocity estimation. With a single SSB, range resolution may be greater than 5 m. However, velocity estimation may be feasible because the velocity estimation granularity (Δv) may be greater than 1000 km/h. TRS/CSI-RS may have a similar capability to PRS from a range resolution perspective. A low density in the frequency domain may cause an aliasing problem for range estimation. In addition, velocity estimation may not be enough with a greater than 200 km/h resolution with two-slot TRS.

LTE has always-on CRSs that is accessible to both connected mode and idle mode UEs. The idle mode UE may use CRSs for channel estimation, downlink synchronization, radio resource management (RRM) measurements, etc. For RF sensing, LTE CRSs may enable high accuracy Doppler estimation for a UE receiver. In the legacy LTE modem implementation, the Doppler may be estimated with CRSs and may be used for channel estimation interpolation, where the phase coherence is guaranteed. One drawback utilizing LTE CRSs for RF sensing include lower range resolution, where the LTE signal bandwidth is much less than the NR signal bandwidth. Another drawback is that the LTE deployment is without massive MIMO beamforming, as it is difficult to utilize a massive MIMO array in a low band, and the angular estimation based on CRS may be challenging.

NR-RSs are incapable of high-resolution target speed estimation and LTE CRSs may potentially enable high-resolution target speed estimation. In accordance with various aspects of the present disclosure, NR-RS and always-on CRS may be combined to enable cellular-based RF sensing with always-on LTE CRSs and NR wideband RSs (such as TRSs/PRSs). In an aspect, join CRS and NR-RS measurement for RF sensing may be enabled. A DSS UE (e.g., a UE that shares the same spectrum for different radio access technology (e.g., NR and LTE)) may leverage the CRS to make the joint sensing with NR-RS. In another aspect, LTE CRS for DSS UE RF sensing may be enabled. For the purposes of the present disclosure, a wideband RS may be referred to as a RS that is transmitted based on the NR signal bandwidth.

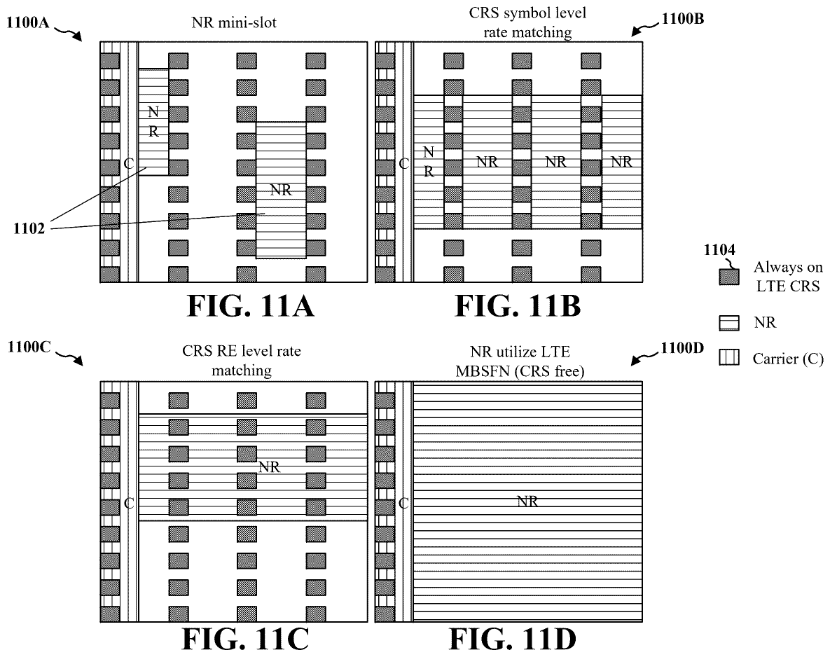

FIGS. 11A-11D depict various NR resource configurations in accordance with various aspects of the present disclosure. In particular, FIG. 11A depicts a diagram 1100A that illustrates NR mini-slots 1102 that are situated between always on LTE-CRSs 1104. The NR mini-slots enable transmission to start at any OFDM symbol and at last the number of symbols that may be needed for communication. FIG. 11B depicts a diagram 1100B that illustrates CRS symbol level rate matching. FIG. 11C depicts a diagram 1100C that illustrates CRS RE level rate matching. FIG. 11D depicts a diagram 1100D that illustrates NR resources that utilize an LTE multimedia broadcast single frequency network (MBSFN), where no CRSs are utilized. CRS RE level rate matching and NR resources utilizing LTE MBSFN may be implemented for DL dynamic spectrum sharing (DSS) implementations.

In accordance with various aspects of the present disclosure, joint CRS and NR-RS measurements may be utilized for RF sensing. For instance, a particular quasi-co-location (QCL) relationship between LTE CRSs and NR-RSs may be defined. In particular, an NR-RS may have a QCL Type C relationship to an LTE CRS from a serving or neighboring TRP. The QCL Type C relationship means that the LTE CRS and the NR-RS are communicated through a similar radio channel, sharing similar properties in terms of average delay and Doppler shift. This association may implicitly indicate that the phase coherence may not be guaranteed for the associated NR-RS.

Based on the QCL relationship between LTE CRSs and NR-RSs, a sensing server (e.g., the LMF 166) and/or a network node (e.g., the gNB) may indicate the LTE CRS pattern to the NR UE to facilitate additional intra-frequency and inter-frequency measurements by NR UE in all RRC states. The sensing server/network node may indicate (e.g., signal) the LTE CRS pattern, a resource identifier (ID), and/or a transmit power offset through a sensing SIB or dedicated RRC signaling. If the UE is purely (e.g., just) enabled with NR capability, the CRS sequence (which may be scrambled with an LTE cell ID) may be additionally signaled to a DSS UE, or at least, that the LTE cell ID is configured. The LTE CRS pattern configured by the network node for the NR UE may be a subset of the CRSs actually transmitted by a network node (e.g., an eNB), which are quasi-co-located with the DL PRS/TRS/CSI-RS. For example, for LTE dynamic TDD, the eNB may transmit CRSs in every subframe. The sensing server/gNB may configure ab NR UE to measure a subset of subframes. Based on such a configuration, a DSS UE may leverage CRSs to make the joint sensing with NR-RSs.

In accordance with various aspects of the present disclosure, LTE CRSs may be utilized for DSS UE-based RF sensing. The CRSs may be treated as sensing RSs in a sensing instance. The CRS sequence (which may be scrambled with the LTE cell ID) may be additionally signaled to the DSS UE, or at least, that the LTE cell ID is configured.

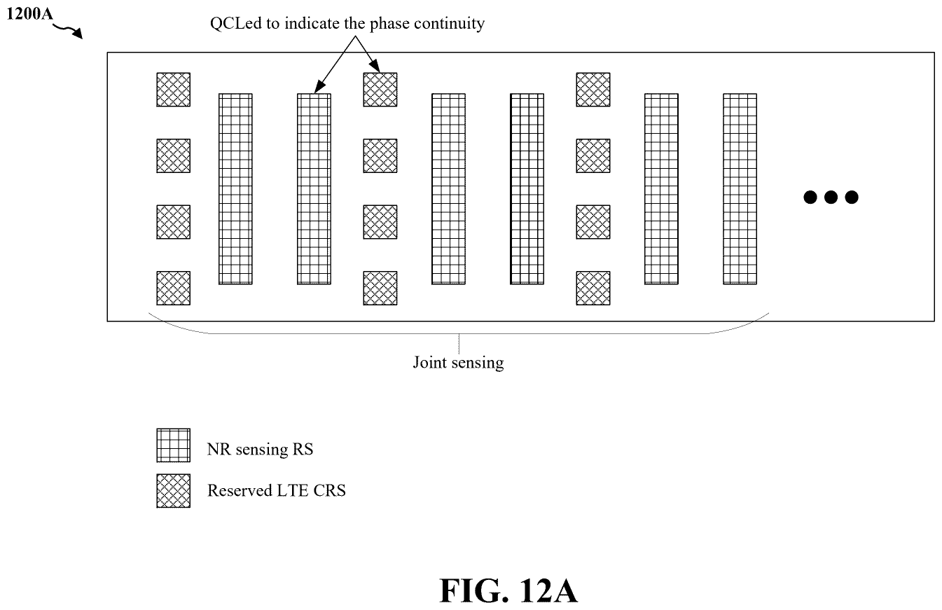

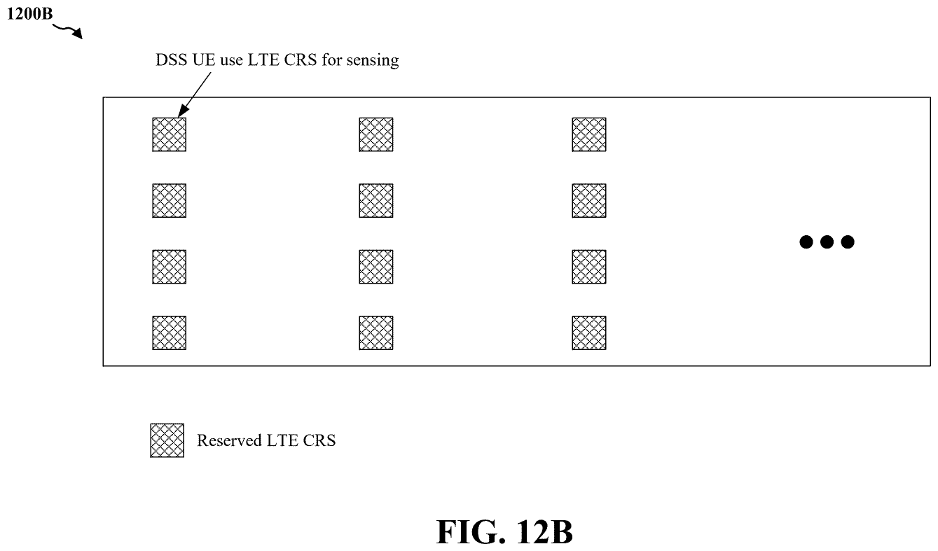

This configuration is different than the configuration described above with reference to joint CRS and NR-RS, as this configuration enables sensing based on LTE CRSs for a DSS UE. For instance, FIG. 12A depicts a diagram 1200A that illustrates joint CRS and NR-RS-based sensing, where both NR-RSs and LTE CRSs are utilized for sensing. As described above, the NR-RSs and the LTE CRSs have a quasi-co-located relationship to indicate phase continuity. FIG. 12B depicts a diagram 1200B that illustrates LTE CRS-based sensing for a DSS UE, where just LTE CRSs are utilized for sensing.

In some aspects, an expected-Doppler value (e.g., an expected value of a Doppler frequency shift with respect to a search window (in which a Doppler frequency offset is searched, for example, by a UE)) and an expected-Doppler uncertainty value (e.g., an expected uncertainty or accuracy value of the Doppler frequency shift) for each TRP may be signaled to a UE to help the UE save its power for Doppler estimation. The Doppler granularity or resolution is related to the window length in the time domain. A larger observation window may enable higher resolution for the Doppler or speed estimation. By configuring such values to the UE, the UE may determine an accurate observation value to obtain the Doppler estimation.

In some aspects, the sensing server/network node may signal additional assistance data for UE-based RF sensing. The assistance data may include the location of the eNB, the boresight direction of the DSS UE that reports the Doppler estimation based on the associated CRS beams, an indication that the UE may skip (e.g., bypass) the Doppler measurement report based on the NR-RSs.

In some aspects, when sensing is based on the gNB or between the gNB, if the eNB and the gNB are co-located, the location of the eNB is the same to the gNB. Thus, a single bit may be used to indicate that the source eNB of the LTE CRSs is co-located with the gNB. If the eNB is unknown to the LTE-based eNB, the position information may be configured to the gNB.

For example, for a DSS UE, the unknown LTE eNB may send the CRSs in the shared spectrum. In bistatic sensing, with the configured CRS configuration, a DSS UE may reuse the CRS for sensing. Such information, for example, the location of the associated eNB, may be useful for the sensing.

In some aspects, multi-port CRSs may support MIMO sensing. For instance, if the gNB and the eNB (or other types of base stations) are not co-located, the eNB may use LTE CRSs for MIMO sensing. If the gNB and the eNB are co-located, the eNB may conduct standalone MIMO sensing. Alternatively, if the gNB and the eNB cooperate with each other and share the same carrier frequency (DSS), the gNB and the eNB may jointly use CRSs and NR-RSs for MIMO sensing. For the purposes of the present disclosure, a MIMO sensing session may be referred to an RF sensing session performed at a base station or TRP, where the base station or TRP transmits reference signals (e.g., CRSs and/or wideband reference signals), receives reference signals, and measures the reference signals (e.g., the Rx-Tx time differences) for the purposes of determining a sensing result or state of an environment in which the target entity is included.

In some aspects, enhancements may be provided for sensing measurements. For instance, a UE may indicate which LTE CRS measurements are being used for a sensing measurement report. NR-RSs may not be able to independently conduct high quality joint speed and range estimation of a target entity. The UE may have the flexibility to use LTE CRSs in any slot for its sensing measurement report.

In some aspects, when utilizing DSS, if a UE supports NR and LTE, the UE may utilize joint sensing and reuse CRSs for sensing. If a UE just supports LTE, based on the sensing configuration, the UE may just reuse the LTE CRS for sensing. If a UE just supports NR, with the CRS configuration, the UE may utilize joint sensing and reuse CRSs for sensing.

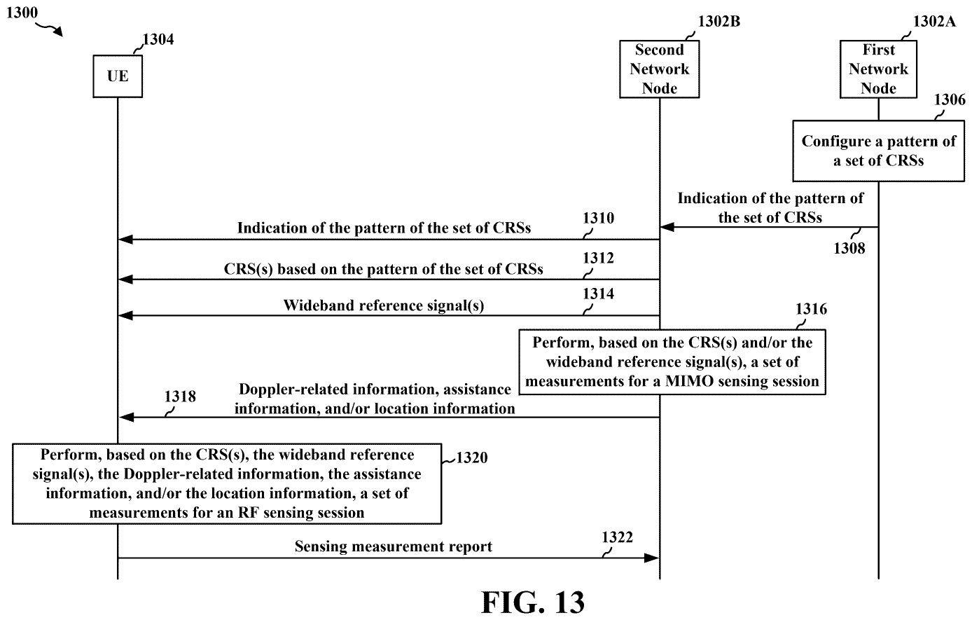

FIG. 13 depicts a call flow diagram 1300 illustrating a method of wireless communication in accordance with various aspects of this present disclosure. As shown in FIG. 13, the diagram 800 includes a first network node 1302A, a second network node 1302B, and a UE 1304. The first network node 1302A may be an example of a base station, such as an eNB, the base station 102, the base station 310, and the second network node 1302B may be an example of the LMF 166 or a base station, such as a gNB, the base station 102, the base station 310, the TRP 402, or the TRP 406. The UE 1304 may be an example of the UE 104, the UE 350, or the UE 404. In an aspect, the UE 1304 is an NR UE. In another aspect, the UE 1304 is a DSS UE. In another aspect, the UE 1304 is an LTE UE. In some aspects, the first network node 1302A and the second network node 1302B are co-located. In other aspects, the first network node 1302A and the second network node 1302B are not co-located. Although aspects are described for the first network node 1302A and the second network node 1302B, the aspects may be performed by the first network node 1302A and the second network node 1302B in aggregation and/or by one or more components of the first network node 1302A and the second network node 1302B (e.g., such as a CU 110, a DU 130, and/or an RU 140). As shown in FIG. 13, at 1306, the first network node 1302A may configure a pattern of a set of CRSs.

At 1308, the first network node 1302A may provide an indication of the pattern of the set of CRSs to the second network node 1302B.

At 1310, the second network node 1302B may provide the indication of the pattern of the set of CRSs to the UE 1304. In some aspects, the UE 1304 may store the indication of the pattern of the CRSs in a memory or a cache associated with the UE 1304. The UE 1304 may utilize the memory or the cache to retrieve the indication of the pattern of the set of CRS for subsequent usage.

At 1312, the second network node 1302B may provide at least one CRS to the UE 1304 based on the pattern of the set of CRSs.

At 1314, the second network node 1302B may provide at least one wideband reference signal to the UE 1304.

In some aspects, the at least one CRS may have a QCL type C relationship with the at least one wideband reference signal.

At 1316, the second network node 1302B may perform, based on the CRS(s) and/or the wideband reference signal(s), a set of measurements for a MIMO sensing session.

For example, in an aspect in which the first network node 1302A and the second network node 1302B are co-located, the second network node 1302B may perform the measurements based on both the CRS(s) and the wideband references signal(s). In an aspect in which the first network node 1302A and the second network node 1302B are not co-located, the second network node 1302B may perform the measurements based just on the CRS(s).

At 1318, the second network node 1302B may provide Doppler-related information, assistance information, and/or location information to the UE 1304.

In an aspect, the Doppler-related information may include at least one of an expected value of a Doppler frequency shift with respect to a search window or an expected uncertainty value of the Doppler frequency shift.

In an aspect, the assistance information may include at least one of a location of the second network node 1302B from which the set of CRSs are provided, a boresight direction of a beam of another UE that provides a Doppler estimation based on the set of CRSs, or an indication as to whether the UE 1304 is to bypass an analysis of a Doppler measurement report associated with the other UE.

In an aspect, the location information may include a first indication of location of the first network node 1302A that configures the pattern of the set of CRSs and/or a second indication that the first network node 1302A is co-located with respect to the second network node 1302B from which the set of CRSs are provided.

At 1320, the UE 1304 may perform, based on the CRS(s), the wideband reference signal(s), the Doppler-related information, the assistance information, and/or the location information (e.g., the first indication and/or the second indication), a set of measurements for an RF sensing session.

For example, in an aspect in which the UE 1304 is a NR UE or a DSS UE, the UE 1304 may perform, based on both the at least one CRS and the at least one wideband reference signal, the assistance information, the Doppler-related information, and/or the location information, the set of measurements for the RF sensing session. In an aspect in which the UE 1304 is an LTE UE, the UE 1304 may perform the set of measurements based on just the at least one CRS, the assistance information, the Doppler-related information, and/or the location information, the set of measurements for the RF sensing session.

At 1322, the UE 1304 may provide a sensing measurement report based on the set of measurements performed for the RF sensing session to the second network node 1302B. In some aspects, the sensing measurement report may indicate a subset of the set of CRSs utilized for the set of the measurements.

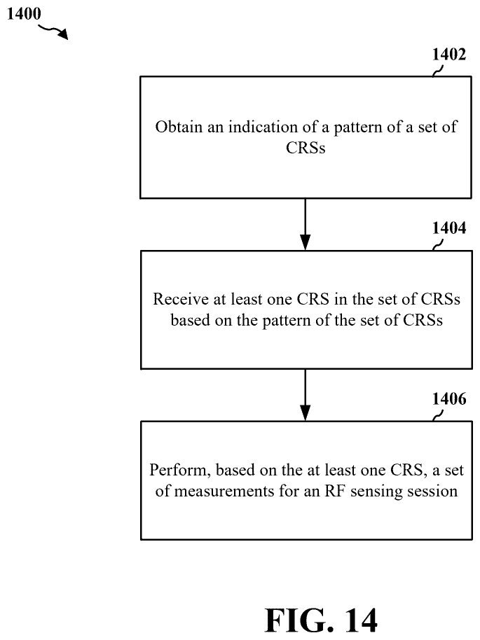

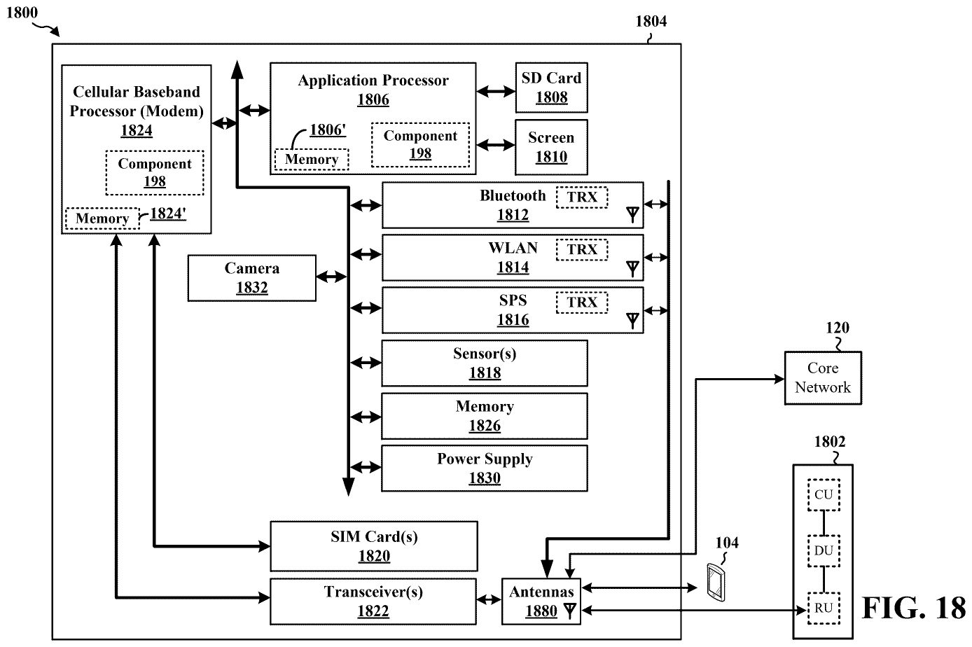

FIG. 14 is a flowchart 1400 illustrating methods of wireless communication at a first UE in accordance with various aspects of the present disclosure. In some aspects, the UE may be the UE 104, 350, 404, or 1304, or the apparatus 1804 in the hardware implementation of FIG. 18.

At 1402, the first UE may obtain an indication of a pattern of a set of CRSs. For example, referring to FIG. 13, the UE 1304 may obtain the indication of the pattern of the set of CRSs at 1310. In an aspect, 1402 may be performed by the RF sensing component 198.

In some aspects, the first UE may obtain the indication of the pattern of the set of CRSs by receiving, from a network node, the indication of the pattern of the set of CRSs or retrieving, from a memory or a cache, the indication of the pattern of the set of CRSs. For example, referring to FIG. 13, the UE 1304, at 1310, may receive, from the second network node 1302B, the indication of the pattern of the set of CRSs. Alternatively, the UE 1304 may retrieve the indication of the pattern of the set of CRSs from a memory or a cache associated with the UE (e.g., the memory 1806′, 1824′ or 1826, as shown in FIG. 18). For instance, the UE 1304 may store the indication of the pattern of the CRSs received at 1310 in the memory or the cache. The UE 1304 may utilize the memory or the cache to retrieve the indication of the pattern of the set of CRSs for subsequent usage.

At 1404, the first UE may receive at least one CRS in the set of CRSs based on the pattern of the set of CRSs. For example, referring to FIG. 13, the UE 1304, at 1312, may receive, from the second network node 1302B, at least one CRS in the set of CRSs based on the pattern of the set of CRSs. In an aspect, 1404 may be performed by the RF sensing component 198.

At 1406, the first UE may perform, based on the at least one CRS, a set of measurements for an RF sensing session. For example, referring to FIG. 13, the UE 1304, at 1320, may perform, based on the at least one CRS, a set of measurements for an RF sensing session. In an aspect, 1406 may be performed by the RF sensing component 198.

In some aspects, the first UE is a NR UE or a DSS UE. For example, referring to FIG. 13, the UE 1304 may be an NR UE or a DSS UE.

In some aspects, the first UE is an LTE UE. For example, referring to FIG. 13, the UE 1304 may be an LTE UE.

In an aspect in which the first UE is an NR UE or a DSS UE (that supports NR), the first UE may receive at least one wideband reference signal and may perform the set of measurements by performing, based on the at least one CRS and the at least one wideband reference signal, the set of measurements for the RF sensing session. For example, referring to FIG. 13, the UE 1304, at 1314, may receive, from the second network node 1302B, at least one wideband reference signal, and at 1320, may perform the set of measurements, based on the at least one CRS and the at least one wideband reference signal, the set of measurements for the RF sensing session.

In some aspects, the at least one CRS may have a QCL type C relationship with the at least one wideband reference signal. For example, referring to FIG. 13, the at least one CRS received at 1312 may have a QCL type C relationship with the at least one wideband reference signal received at 1314.

In some aspects, the first UE may receive at least one of an expected value of a Doppler frequency shift with respect to a search window or an expected uncertainty value of the Doppler frequency shift. For example, referring to FIG. 13, the UE 1304, at 1318, may receive, from the second network node 1302B, at least one of an expected value of a Doppler frequency shift with respect to a search window or an expected uncertainty value of the Doppler frequency shift.

In some aspects, the first UE may receive assistance data for the RF sensing session. For example, referring to FIG. 13, the UE 1304, at 1318, may receive, from the second network node 1302B, assistance data for the RF sensing session.

In some aspects, the assistance data includes at least one of a location of a network node associated with the set of CRSs, a boresight direction of a beam of a second UE that provides a Doppler estimation based on the set of CRSs, or an indication as to whether the first UE is to bypass an analysis of a Doppler measurement report associated with the second UE. For example, referring to FIG. 13, the assistance data received at 1318 may receive at least one of a location of the second network node 1302B from which the set of CRSs are provided, a boresight direction of a beam of another UE that provides a Doppler estimation based on the set of CRSs, or an indication as to whether the UE 1304 is to bypass an analysis of a Doppler measurement report associated with the other UE.

In some aspects, the first UE may perform the set of measurements by performing, based on the at least one CRS and the assistance data, the set of measurements for the RF sensing session. For example, referring to FIG. 13, the UE 1304, at 1320, may perform the set of measurements based on the at least one CRS and the assistance data.

In some aspects, the first UE may receive a first indication of a location of a first network node that configures the pattern of the set of CRSs, and receiving a second indication that the first network node is co-located with respect to a second network node associated with the set of CRSs. The first UE may perform the set of measurements for the RF sensing session by performing the set of measurements for the RF sensing session based on the at least one CRS, the first indication, and the second indication. For example, referring to FIG. 13, the UE 1304, at 1318, may receive, from the second network node 1302B, a first indication of a location of the first network node 1302A that configures the pattern of the set of CRSs, and receive a second indication that the first network node 1302A is co-located with respect to the second network node 1302B associated with the set of CRSs. The UE 1304, at 1320, may perform the set of measurements for the RF sensing session based on the at least one CRS, the first indication, and the second indication.

In some aspects, the first UE may receive an indication of a location of a first network node that configures the pattern of the set of CRSs. The first UE may perform the set of measurements for the RF sensing session by performing the set of measurements for the RF sensing session based on the at least one CRS and the indication. For example, referring to FIG. 13, the UE 1304, at 1318, may receive, from the second network node 1302B, an indication of a location of the first network node 1302A that configures the pattern of the set of CRSs (and not the second indication described above, for example, in a scenario in which the first network node 1302A and the second network node 1302B are not co-located). The UE 1304, at 1320, may perform the set of measurements for the RF sensing session based on the at least one CRS and the indication.

In some aspects, the first UE may transmit a sensing measurement report that is based on the set of measurements, where the sensing measurement report indicates a subset of the set of CRSs utilized for the set of the measurements. For example, referring to FIG. 13, the UE 1304, at 1322, may transmit, to the second network node 1302B, a sensing measurement report that is based on the set of measurements performed at 1320, where the sensing measurement report indicates a subset of the set of CRSs utilized for the set of the measurements.

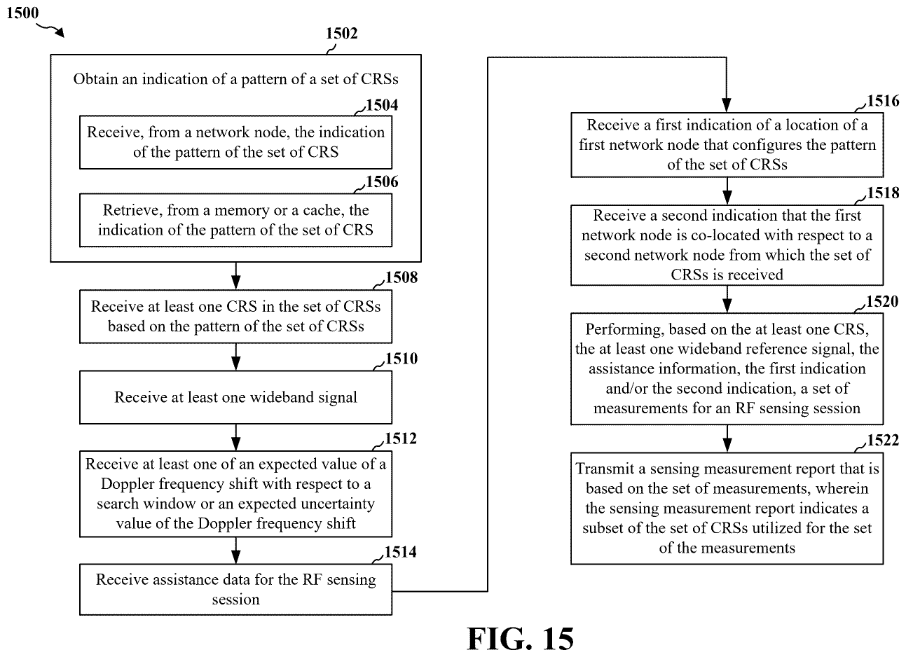

FIG. 15 is a flowchart 1500 illustrating methods of wireless communication at a first UE in accordance with various aspects of the present disclosure. In some aspects, the UE may be the UE 104, 350, 404, or 1304, or the apparatus 1804 in the hardware implementation of FIG. 18.

At 1502, the first UE may obtain an indication of a pattern of a set of CRSs. For example, referring to FIG. 13, the UE 1304 may obtain the indication of the pattern of the set of CRSs at 1310. In an aspect, 1502 may be performed by the RF sensing component 198.

In some aspects, as part of 1502, at 1504, the first UE may obtain the indication of the pattern of the set of CRSs by receiving, from a network node, the indication of the pattern of the set of CRSs or retrieving, from a memory or a cache, the indication of the pattern of the set of CRSs. For example, referring to FIG. 13, the UE 1304, at 1310, may receive, from the second network node 1302B, the indication of the pattern of the set of CRSs. In an aspect, 1504 may be performed by the RF sensing component 198.

In some aspects, as part of 1502, at 1506, the UE 1304 may retrieve the indication of the pattern of the set of CRSs from a memory or a cache associated with the UE (e.g., the memory 1806′, 1824′ or 1826, as shown in FIG. 18). For instance, the UE 1304 may store the indication of the pattern of the CRSs received at 1310 in the memory or the cache. The UE 1304 may utilize the memory or the cache to retrieve the indication of the pattern of the set of CRSs for subsequent usage. In an aspect, 1506 may be performed by the RF sensing component 198.

At 1508, the first UE may receive at least one CRS in the set of CRSs based on the pattern of the set of CRSs. For example, referring to FIG. 13, the UE 1304, at 1312, may receive, from the second network node 1302B, at least one CRS in the set of CRSs based on the pattern of the set of CRSs. In an aspect, 1508 may be performed by the RF sensing component 198.

In some aspects, the first UE is a NR UE or a DSS UE. For example, referring to FIG. 13, the UE 1304 may be an NR UE or a DSS UE.

In some aspects, the first UE is an LTE UE. For example, referring to FIG. 13, the UE 1304 may be an LTE UE.

In an aspect in which the first UE is an NR UE or a DSS UE (that supports NR), at 1510, the first UE may receive at least one wideband reference signal. In an aspect, 1510 may be performed by the RF sensing component 198.

In some aspects, the at least one CRS may have a QCL type C relationship with the at least one wideband reference signal. For example, referring to FIG. 13, the at least one CRS received at 1312 may have a QCL type C relationship with the at least one wideband reference signal received at 1314.

In some aspects, at 1512, the first UE may receive at least one of an expected value of a Doppler frequency shift with respect to a search window or an expected uncertainty value of the Doppler frequency shift. For example, referring to FIG. 13, the UE 1304, at 1318, may receive, from the second network node 1302B, at least one of an expected value of a Doppler frequency shift with respect to a search window or an expected uncertainty value of the Doppler frequency shift. In an aspect, 1512 may be performed by the RF sensing component 198.

In some aspects, at 1514, the first UE may receive assistance data for the RF sensing session. For example, referring to FIG. 13, the UE 1304, at 1318, may receive, from the second network node 1302B, assistance data for the RF sensing session. In an aspect, 1514 may be performed by the RF sensing component 198.

In some aspects, the assistance data may include at least one of a location of a network node associated with the set of CRSs, a boresight direction of a beam of a second UE that provides a Doppler estimation based on the set of CRSs, or an indication as to whether the first UE is to bypass an analysis of a Doppler measurement report associated with the second UE. For example, referring to FIG. 13, the assistance data received at 1318 may receive at least one of a location of the second network node 1302B from which the set of CRSs are provided, a boresight direction of a beam of another UE that provides a Doppler estimation based on the set of CRSs, or an indication as to whether the UE 1304 is to bypass an analysis of a Doppler measurement report associated with the other UE.

In some aspects, at 1516, the first UE may receive a first indication of a location of a first network node that configures the pattern of the set of CRSs. For example, referring to FIG. 13, the UE 1304, at 1318, may receive, from the second network node 1302B, a first indication of a location of the first network node 1302A that configures the pattern of the set of CRSs. The UE 1304 may receive the first indication regardless of whether the first network node 1302A and the second network node 1302B are co-located. In an aspect, 1516 may be performed by the RF sensing component 198.

In some aspects, at 1518, the first UE may receive a second indication that the first network node is co-located with respect to a second network node associated with the set of CRSs. For example, referring to FIG. 13, the UE 1304, at 1318, receive a second indication that the first network node 1302A is co-located with respect to the second network node 1302B associated with the set of CRSs. The UE 1304 may receive the first indication if the first network node 1302A and the second network node 1302B are co-located. In an aspect, 1518 may be performed by the RF sensing component 198.

At 1520, the first UE may perform, based on the at least one CRS, the at least one wideband reference signal, the assistance information, the first indication and/or the second indication, a set of measurements for an RF sensing session. For example, referring to FIG. 13, in an aspect in which the UE 1304 is an LTE UE, the UE 1304 may perform the set of measurements based on just the at least on CRS received at 1312, the assistance information, if received at 1318, the first indication, if received at 1318, and/or the second indication, if received at 1318. In an aspect in which the UE 1304 is an NR UE or a DSS UE, the UE 1304 may perform the set of measurements based on the at least on CRS received at 1312, the at least one wideband signal received at 1314, the assistance information, if received at 1318, the first indication, if received at 1318, and/or the second indication, if received at 1318. In an aspect, 1520 may be performed by the RF sensing component 198.

At 1522, the first UE may transmit a sensing measurement report that is based on the set of measurements, where the sensing measurement report indicates a subset of the set of CRSs utilized for the set of the measurements. For example, referring to FIG. 13, the UE 1304, at 1322, may transmit, to the second network node 1302B, a sensing measurement report that is based on the set of measurements performed at 1320, where the sensing measurement report indicates a subset of the set of CRSs utilized for the set of the measurements. In an aspect, 1522 may be performed by the RF sensing component 198.

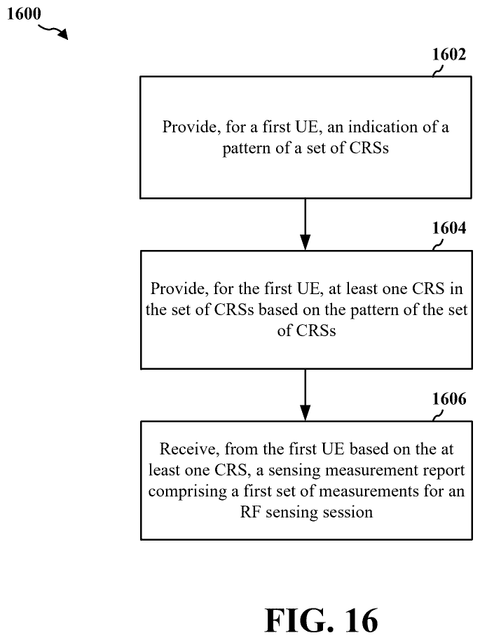

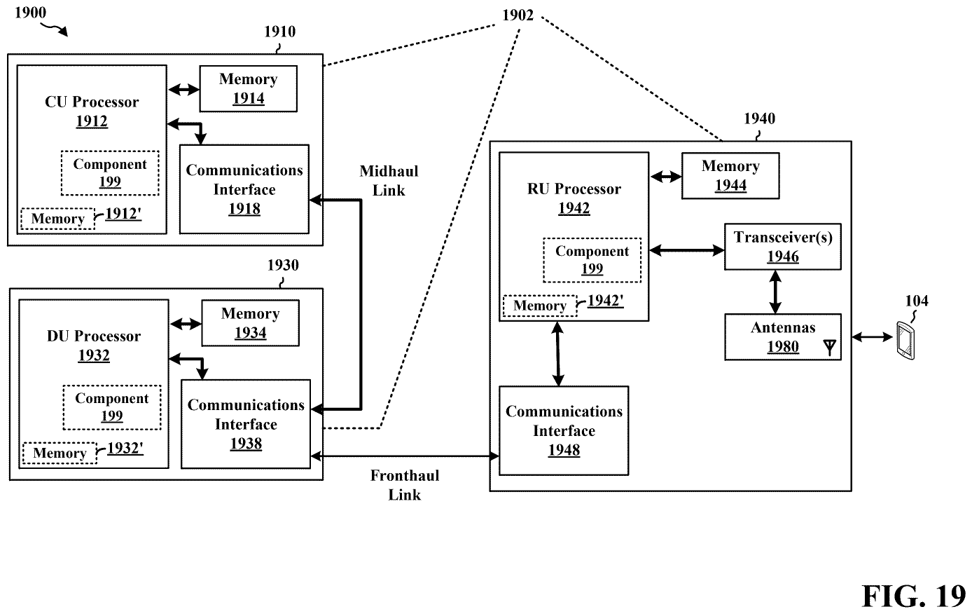

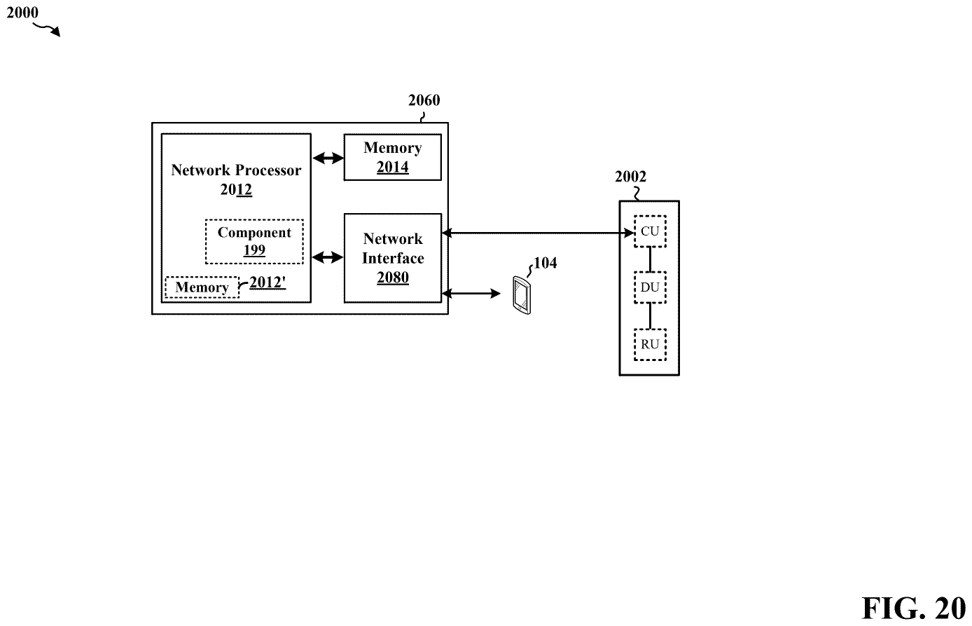

FIG. 16 is a flowchart 1600 illustrating methods of wireless communication at a first network node in accordance with various aspects of the present disclosure. In some aspects, the first network node may be the base station 102, the LMF 166, the base station 310, the TRP 402, the TRP 406, the second network node 1302B, the network entity 1902 in the hardware implementation of FIG. 19, or the network entity 2060 in the hardware implementation of FIG. 20.

At 1602, the first network node may provide, for a first UE, an indication of a pattern of a set of CRSs. For example, referring to FIG. 13, the second network node 1302B, at 1310, may provide, for the UE 1304, an indication of a pattern of a set of CRSs. In an aspect, 1602 may be performed by the RF sensing component 199.

In some aspects, the first network node may receive, from a second network node, a configuration for the pattern of the set of CRSs. For example, referring to FIG. 13, at 1308, the second network node 1302B may receive, from the first network node 1302A, a configuration for the pattern of the set of CRSs.

In some aspects, the first network node and the second network node may be co-located. For example, referring to FIG. 13, the second network node 1302B and the first network node 1302A may be co-located.

In some aspects, the first network node and the second network node may not be co-located. For example, referring to FIG. 13, the second network node 1302B and the first network node 1302A may not be co-located.

At 1604, the first network node may provide, for the first UE, at least one CRS in the set of CRSs based on the pattern of the set of CRSs. For example, referring to FIG. 13, the second network node 1302B, at 1312, may provide, for the UE 1304, at least one CRS in the set of CRSs based on the pattern of the set of CRSs. In an aspect, 1604 may be performed by the RF sensing component 199.

At 1606, the first network node may receive, from the first UE based on the at least one CRS, a sensing measurement report including a first set of measurements for an RF sensing session. For example, referring to FIG. 13, the second network node 1302B, at 1322, may receive, from the UE 1304 based on the at least one CRS, a sensing measurement report including a first set of measurements for an RF sensing session. In an aspect, 1606 may be performed by the RF sensing component 199.

In some aspects, the sensing measurement report may indicate a subset of the set of CRSs utilized to generate the sensing measurement report. For example, referring to FIG. 13, the sensing measurement report received at 1322 may indicate a subset of the set of CRSs utilized to generate the sensing measurement report.

In some aspects, the first network node may provide, for the first UE, at least one wideband reference signal, where the first set of measurements for the RF sensing session is further based on the at least one wideband reference signal. For example, referring to FIG. 13, the second network node 1302B, at 1314, may provide, for the UE 1304, at least one wideband reference signal, where the first set of measurements for the RF sensing session is further based on the at least one wideband reference signal.

In some aspects, the at least one CRS may have a QCL type C relationship with the at least one wideband reference signal. For example, referring to FIG. 13, the at least one CRS provided at 1312 may have a QCL type C relationship with the at least one wideband reference signal provided at 1314.

In some aspects, the first network node may provide at least one of an expected value of a Doppler frequency shift with respect to a search window or an expected uncertainty value of the Doppler frequency shift. For example, referring to FIG. 13, the second network node 1302B, at 1318, may provide at least one of an expected value of a Doppler frequency shift with respect to a search window or an expected uncertainty value of the Doppler frequency shift.

In some aspects, the first network node may provide, for the first UE, assistance data for the RF sensing session. For example, referring to FIG. 13, the second network node 1302B, at 1318, may provide, for the UE 1304, assistance data for the RF sensing session.

In some aspects, the assistance data may include at least one of a location of the first network node, a boresight direction of a beam of a second UE that provides a Doppler estimation based on the set of CRSs, or an indication as to whether the first UE is to bypass an analysis of a Doppler measurement report associated with the second UE. For example, referring to FIG. 13, the assistance data provided at 1318 may include at least one of a location of the second network node 1302B, a boresight direction of a beam of another UE that provides a Doppler estimation based on the set of CRSs, or an indication as to whether the UE 1304 is to bypass an analysis of a Doppler measurement report associated with the other UE.

In some aspects, the first set of measurements for the RF sensing session may be based on the assistance data. For example, referring to FIG. 13, the first set of measurements of the measurement report received at 1322 may be based on the assistance data.

In some aspects, the first network node may provide, for the first UE, at least one of a first indication of a location of a second network node that configures the pattern of the set of CRSs or a second indication that the first network node is co-located with respect to the second network node. For example, referring to FIG. 13, at 1318, the second network node 1302B may provide, for the UE 1304, at least one of a first indication of a location of the first network node 1302A that configures the pattern of the set of CRSs or a second indication that the second network node 1302B is co-located with respect to the first network node 1302A.

In an aspect in which the first network node and the second network node are co-located, the first network node may perform a second set of measurements for a MIMO sensing session based on at least one of the at least one CRS or at least one wideband signal. For example, referring to FIG. 13, the second network node 1302B, at 1316, may perform a second set of measurements for a MIMO sensing session based on at least one of the at least one CRS provided at 1312 or the at least one wideband signal provided at 1318.

In an aspect in which the first network node and the second network node are not co-located, the first network node may perform a second set of measurements for a MIMO sensing session based on at least one of the at least one CRS. For example, referring to FIG. 13, the second network node 1302B, at 1316, may perform a second set of measurements for a MIMO sensing session based on just the at least one CRS provided at 1312.

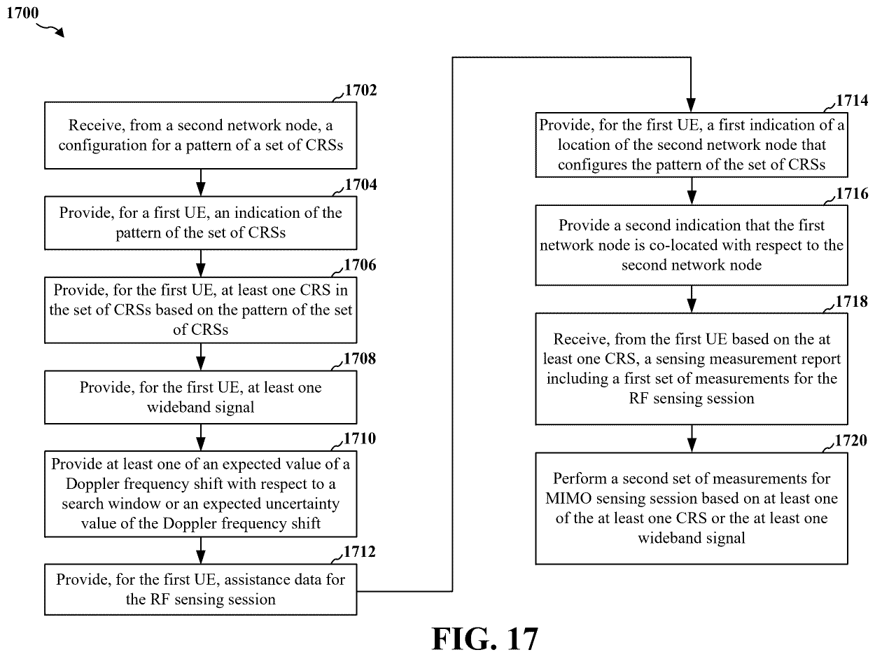

FIG. 17 is a flowchart 1700 illustrating methods of wireless communication at a first network node in accordance with various aspects of the present disclosure. In some aspects, the first network node may be the base station 102, the LMF 166, the base station 310, the TRP 402, the TRP 406, the second network node 1302B, the network entity 1902 in the hardware implementation of FIG. 19, or the network entity 2060 in the hardware implementation of FIG. 20.

At 1702, the first network node may receive, from a second network node, a configuration for a pattern of a set of CRSs. For example, referring to FIG. 13, at 1308, the second network node 1302B may receive, from the first network node 1302A, a configuration for the pattern of the set of CRSs. In an aspect, 1702 may be performed by the RF sensing component 199.

At 1704, the first network node may provide, for a first UE, an indication of the pattern of the set of CRSs. For example, referring to FIG. 13, the second network node 1302B, at 1310, may provide, for the UE 1304, an indication of the pattern of the set of CRSs. In an aspect, 1704 may be performed by the RF sensing component 199.

In some aspects, the first network node and the second network node may be co-located. For example, referring to FIG. 13, the second network node 1302B and the first network node 1302A may be co-located.

In some aspects, the first network node and the second network node may not be co-located. For example, referring to FIG. 13, the second network node 1302B and the first network node 1302A may not be co-located.

At 1706, the first network node may provide, for the first UE, at least one CRS in the set of CRSs based on the pattern of the set of CRSs. For example, referring to FIG. 13, the second network node 1302B, at 1312, may provide, for the UE 1304, at least one CRS in the set of CRSs based on the pattern of the set of CRSs. In an aspect, 1706 may be performed by the RF sensing component 199.

In some aspects, at 1708, the first network node may provide, for the first UE, at least one wideband reference signal, where the first set of measurements for the RF sensing session is further based on the at least one wideband reference signal. For example, referring to FIG. 13, the second network node 1302B, at 1314, may provide, for the UE 1304, at least one wideband reference signal, where the first set of measurements for the RF sensing session is further based on the at least one wideband reference signal. In an aspect, 1708 may be performed by the RF sensing component 199.

In some aspects, the at least one CRS may have a QCL type C relationship with the at least one wideband reference signal. For example, referring to FIG. 13, the at least one CRS provided at 1312 may have a QCL type C relationship with the at least one wideband reference signal provided at 1314.

In some aspects, at 1710, the first network node may provide at least one of an expected value of a Doppler frequency shift with respect to a search window or an expected uncertainty value of the Doppler frequency shift. For example, referring to FIG. 13, the second network node 1302B, at 1318, may provide at least one of an expected value of a Doppler frequency shift with respect to a search window or an expected uncertainty value of the Doppler frequency shift. In an aspect, 1710 may be performed by the RF sensing component 199.

In some aspects, at 1712, the first network node may provide, for the first UE, assistance data for the RF sensing session. For example, referring to FIG. 13, the second network node 1302B, at 1318, may provide, for the UE 1304, assistance data for the RF sensing session. In an aspect, 1712 may be performed by the RF sensing component 199.

In some aspects, the assistance data may include at least one of a location of the first network node, a boresight direction of a beam of a second UE that provides a Doppler estimation based on the set of CRSs, or an indication as to whether the first UE is to bypass an analysis of a Doppler measurement report associated with the second UE. For example, referring to FIG. 13, the assistance data provided at 1318 may include at least one of a location of the second network node 1302B, a boresight direction of a beam of another UE that provides a Doppler estimation based on the set of CRSs, or an indication as to whether the UE 1304 is to bypass an analysis of a Doppler measurement report associated with the other UE.

In some aspects, at 1714, the first network node may provide, for the first UE, a first indication of a location of the second network node that configures the pattern of the set of CRSs or a second indication that the first network node is co-located with respect to the second network node. For example, referring to FIG. 13, at 1318, the second network node 1302B may provide, for the UE 1304, a first indication of a location of the first network node 1302A that configures the pattern of the set of CRSs or a second indication that the second network node 1302B is co-located with respect to the first network node 1302A. In an aspect, 1714 may be performed by the RF sensing component 199.

In some aspects at 1716, In some aspects, at 1714, the first network node may provide, for the first UE, a second indication that the first network node is co-located with respect to the second network node. For example, referring to FIG. 13, at 1318, the second network node 1302B may provide, for the UE 1304, a second indication that the second network node 1302B is co-located with respect to the first network node 1302A. In an aspect, 1716 may be performed by the RF sensing component 199.

At 1718, the first network node may receive, from the first UE based on the at least one CRS, a sensing measurement report including a first set of measurements for an RF sensing session. For example, referring to FIG. 13, the second network node 1302B, at 1322, may receive, from the UE 1304 based on the at least one CRS, a sensing measurement report including a first set of measurements for an RF sensing session. In an aspect, 1718 may be performed by the RF sensing component 199.

In some aspects, the sensing measurement report may indicate a subset of the set of CRSs utilized to generate the sensing measurement report. For example, referring to FIG. 13, the sensing measurement report received at 1322 may indicate a subset of the set of CRSs utilized to generate the sensing measurement report.

In some aspects, the first set of measurements for the RF sensing session may be based on the assistance data. For example, referring to FIG. 13, the first set of measurements of the measurement report received at 1322 may be based on the assistance data.

In some aspects, at 1720, the first network node may perform a second set of measurements for MIMO sensing session based on at least one of the at least one CRS or the at least one wideband signal. For example, referring to FIG. 13, at 1316, the second network node 1302B may perform a second set of measurements for MIMO sensing session based on at least one of the at least one CRS provided at 1312 or the at least one wideband signal provided at 1314. In an aspect, 1720 may be performed by the RF sensing component 199.

In an aspect in which the first network node and the second network node are co-located, the first network node may perform a second set of measurements for a MIMO sensing session based on at least one of the at least one CRS or at least one wideband signal. For example, referring to FIG. 13, the second network node 1302B, at 1316, may perform a second set of measurements for a MIMO sensing session based on at least one of the at least one CRS provided at 1312 or the at least one wideband signal provided at 1318.

In an aspect in which the first network node and the second network node are not co-located, the first network node may perform a second set of measurements for a MIMO sensing session based on at least one of the at least one CRS. For example, referring to FIG. 13, the second network node 1302B, at 1316, may perform a second set of measurements for a MIMO sensing session based on just the at least one CRS provided at 1312.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104, the core network 120, and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see UE 350 of FIG. 3) and include the additional modules of the apparatus 1804.

As discussed supra, the component 198 may be configured to obtain an indication of a pattern of a set of CRSs, receive at least one CRS in the set of CRSs based on the pattern of the set of CRSs, and perform, based on the at least one CRS, a set of measurements for an RF sensing session. The component 198 may be configured to perform any of the aspects described in connection with the flowcharts in FIGS. 14 and 15 and/or the aspects performed by the UE 1304 in the communication flow in FIG. 13. The component 198 may be within the cellular baseband processor 1824, the application processor 1806, or both the cellular baseband processor 1824 and the application processor 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, may include means for obtaining an indication of a pattern of a set of CRSs, means for receiving at least one CRS in the set of CRSs based on the pattern of the set of CRSs, and means for performing, based on the at least one CRS, a set of measurements for an RF sensing session. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, for a first UE, an indication of a pattern of a set of CRSs, provide, for the first UE, at least one CRS in the set of CRSs based on the pattern of the set of CRSs, and receive, from the first UE based on the at least one CRS, a sensing measurement report including a first set of measurements for an RF sensing session. The component 199 may be configured to perform any of the aspects described in connection with the flowchart in FIGS. 16 and 17 and/or the aspects performed by the second network node 1302B in the communication flow in FIG. 13. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 may include means for providing, for a first UE, an indication of a pattern of a set of CRSs, means for providing, for the first UE, at least one CRS in the set of CRSs based on the pattern of the set of CRSs, and means for receiving, from the first UE based on the at least one CRS, a sensing measurement report including a first set of measurements for an RF sensing session. The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 20 is a diagram 2000 illustrating an example of a hardware implementation for a network entity 2060. In one example, the network entity 2060 may be within the core network 120. The network entity 2060 may include a network processor 2012. The network processor 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002 and the UE 104. The on-chip memory 2012′ and the additional memory modules 2014 may each be considered a computer-readable medium/memory. Each computer-readable medium/memory may be non-transitory. The processor 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide, for a first UE, an indication of a pattern of a set of CRSs, provide, for the first UE, at least one CRS in the set of CRSs based on the pattern of the set of CRSs, and receive, from the first UE based on the at least one CRS, a sensing measurement report including a first set of measurements for an RF sensing session. The component 199 may be configured to perform any of the aspects described in connection with the flowchart in FIGS. 16 and 17 and/or the aspects performed by the second network node 1302B in the communication flow in FIG. 13. The component 199 may be within the processor 2012. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2060 may include a variety of components configured for various functions. In one configuration, the network entity 2060 may include means for providing, for a first UE, an indication of a pattern of a set of CRSs, means for providing, for the first UE, at least one CRS in the set of CRSs based on the pattern of the set of CRSs, and means for receiving, from the first UE based on the at least one CRS, a sensing measurement report including a first set of measurements for an RF sensing session. The means may be the component 199 of the network entity 2060 configured to perform the functions recited by the means.

Various aspects relate generally to positioning systems. Some aspects more specifically relate to joint CRS and NR reference signal measurements for RF sensing. In some examples, a network node may provide, to a UE (e.g., an NR UE or a DSS UE), an indication of a pattern of a set of CRSs (e.g., always-on LTE CRSs). The network node may provide one or more CRSs to the UE based on the pattern. The network node may also provide, to the UE, one or more wideband reference signals. The UE may perform a set of measurements for an RF sensing session based on the CRS(s) and/or wideband reference signal(s).

Particular aspects of the subject matter described in this disclosure can be implemented to realize one or more of the following potential advantages. In some examples, NR UEs or DSS UEs may be incapable of high-resolution target speed estimation and high accuracy Doppler estimation when performing measurements using just wideband reference signals. By providing CRSs to a NR UE or a DSS UE, along with the wideband reference signals, the NR UE or the DSS UE may perform high-resolution target speed estimation and high accuracy Doppler estimation via measurements based on the CRSs and the wideband reference signals. By doing so, the target speed and/or location of the target may be more accurately estimated.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE, including obtaining an indication of a pattern of a set of CRSs; receiving at least one CRS in the set of CRSs based on the pattern of the set of CRSs; and performing, based on the at least one CRS, a set of measurements for an RF sensing session.

Aspect 2 is the method of aspect 1, further including: receiving at least one wideband reference signal; where performing the set of measurements includes: performing, based on the at least one CRS and the at least one wideband reference signal, the set of measurements for the RF sensing session.

Aspect 3 is the method of any of aspects 1 and 2, where the first UE is an NR UE or a DSS UE.

Aspect 4 is the method of any of aspects 1 to 3, where the at least one CRS has a QCL type C relationship with the at least one wideband reference signal.

Aspect 5 is the method of any of aspects 1 to 4, further including: receiving at least one of: an expected value of a Doppler frequency shift with respect to a search window; or an expected uncertainty value of the Doppler frequency shift.

Aspect 6 is the method of any of aspects 1 to 5, further including: receiving assistance data for the RF sensing session.

Aspect 7 is the method of aspect 6, where the assistance data includes at least one of: a location of a network node associated with the set of CRSs; a boresight direction of a beam of a second UE that provides a Doppler estimation based on the set of CRSs; or an indication as to whether the first UE is to bypass an analysis of a Doppler measurement report associated with the second UE.

Aspect 8 is the method of any of aspects 6 and 7, where performing the set of measurements includes: performing, based on the at least one CRS and the assistance data, the set of measurements for the RF sensing session.

Aspect 9 is the method of any of aspects 1 to 8, further including: receiving a first indication of a location of a first network node that configures the pattern of the set of CRSs; and receiving a second indication that the first network node is co-located with respect to a second network node associated with the set of CRSs, where performing the set of measurements for the RF sensing session includes: performing the set of measurements for the RF sensing session based on the at least one CRS, the first indication, and the second indication.

Aspect 10 is the method of any of aspects 1 to 9, further including: receiving an indication of a location of a first network node that configures the pattern of the set of CRSs, where performing the set of measurements for the RF sensing session includes: performing the set of measurements for the RF sensing session based on the least one CRS and the indication.

Aspect 11 is the method of any of aspects 1 to 10, further including: transmitting a sensing measurement report that is based on the set of measurements, where the sensing measurement report indicates a subset of the set of CRSs utilized for the set of measurements.

Aspect 12 is the method of any of aspects 1 to 11, where obtaining the indication of the pattern of the set of CRSs includes: receiving, from a network node, the indication of the pattern of the set of CRS; or retrieving, from a first memory or a cache, the indication of the pattern of the set of CRS.

Aspect 13 is a method of wireless communication at a first network node, including providing, for a first UE, an indication of a pattern of a set of CRSs; providing, for the first UE, at least one CRS in the set of CRSs based on the pattern of the set of CRSs; and receiving, from the first UE based on the at least one CRS, a sensing measurement report including a first set of measurements for an RF sensing session.

Aspect 14 is the method of aspect 13, further including: providing, for the first UE, at least one wideband reference signal, where the first set of measurements for the RF sensing session is further based on the at least one wideband reference signal.

Aspect 15 is the method of aspect 14, where the at least one CRS has a QCL type C relationship with the at least one wideband reference signal.

Aspect 16 is the method of any of aspects 13 to 15, further including: providing at least one of: an expected value of a Doppler frequency shift with respect to a search window; or an expected uncertainty value of the Doppler frequency shift.

Aspect 17 is the method of any of aspects 13 to 16, further including: providing, for the first UE, assistance data for the RF sensing session.

Aspect 18 is the method of aspect 17, where the assistance data includes at least one of: a location of the first network node; a boresight direction of a beam of a second UE that provides a Doppler estimation based on the set of CRSs; or an indication as to whether the first UE is to bypass an analysis of a Doppler measurement report associated with the second UE.

Aspect 19 is the method of any of aspects 17 and 18, where the first set of measurements for the RF sensing session is based on the assistance data.

Aspect 20 is the method of any of aspects 13 to 19, further including: providing, for the first UE, at least one of: a first indication of a location of a second network node that configures the pattern of the set of CRSs; or a second indication that the first network node is co-located with respect to the second network node.

Aspect 21 is the method of any of aspects 13 to 20, where the sensing measurement report indicates a subset of the set of CRSs utilized to generate the sensing measurement report.

Aspect 22 is the method of any of aspects 13 to 21, further including: receiving, from a second network node, a configuration for the pattern of the set of CRSs.

Aspect 23 is the method of any of aspects 13 to 22, where the first network node is co-located with respect to the second network node.

Aspect 24 is the method of aspect 23, further including: performing a second set of measurements for a multiple-input multiple-output (MIMO) sensing session based on at least one of: the at least one CRS; or at least one wideband signal.

Aspect 25 is the method of any of aspects 13 to 22, where the first network node is not co-located with respect to the second network node.

Aspect 26 is the method of aspect 25, further including: performing a second set of measurements for a multiple-input multiple-output (MIMO) sensing session based on the at least one CRS.

Aspect 27 is an apparatus for wireless communication at a first UE. The apparatus includes memory; and at least one processor coupled to the memory and, based at least in part on information stored in the memory, the at least one processor is configured to implement any of aspects 1 to 12.

Aspect 28 is the apparatus of aspect 27, further including at least one of a transceiver or an antenna coupled to the at least one processor.

Aspect 29 is an apparatus for wireless communication at a first network node. The apparatus includes memory; and at least one processor coupled to the memory and, based at least in part on information stored in the memory, the at least one processor is configured to implement any of aspects 13 to 26.

Aspect 30 is the apparatus of aspect 29, further including at least one of a transceiver or an antenna coupled to the at least one processor.

Aspect 31 is an apparatus for wireless communication including means for implementing any of aspects 1 to 12.

Aspect 32 is an apparatus for wireless communication including means for implementing any of aspects 13 to 26.

Aspect 33 is a computer-readable medium (e.g., a non-transitory computer-readable medium) storing computer executable code, where the code when executed by a processor causes the processor to implement any of aspects 1 to 12.

Aspect 34 is a computer-readable medium (e.g., a non-transitory computer-readable medium) storing computer executable code, where the code when executed by a processor causes the processor to implement any of aspects 13 to 26.

1. An apparatus of wireless communication at a first user equipment (UE), comprising:
a memory; and
at least one processor coupled to the memory and, based at least in part on information stored in the memory, the at least one processor is configured to:
obtain an indication of a pattern of a set of cell-specific reference signals (CRSs);
receive at least one CRS in the set of CRSs based on the pattern of the set of CRSs; and
perform, based on the at least one CRS, a set of measurements for a radio frequency (RF) sensing session.

2. The apparatus of claim 1, wherein the at least one processor is further configured to:
receive at least one wideband reference signal;
wherein, to perform the set of measurements, the at least one processor is configured to:
perform, based on the at least one CRS and the at least one wideband reference signal, the set of measurements for the RF sensing session.

3. The apparatus of claim 2, wherein the first UE is a new radio (NR) UE or dynamic spectrum sharing (DSS) UE.

4. The apparatus of claim 2, wherein the at least one CRS has a quasi-co-location (QCL) type C relationship with the at least one wideband reference signal.

5. The apparatus of claim 1, wherein the first UE is a long-term evolution (LTE) UE.

6. The apparatus of claim 1, wherein the at least one processor is further configured to:
receive at least one of:
an expected value of a Doppler frequency shift with respect to a search window; or
an expected uncertainty value of the Doppler frequency shift.

7. The apparatus of claim 1, wherein the at least one processor is further configured to:
receive assistance data for the RF sensing session.

8. The apparatus of claim 7, wherein the assistance data comprises at least one of:
a location of a network node associated with the set of CRSs;
a boresight direction of a beam of a second UE that provides a Doppler estimation based on the set of CRSs; or
an indication as to whether the first UE is to bypass an analysis of a Doppler measurement report associated with the second UE.

9. (canceled)

10. The apparatus of claim 1, wherein the at least one processor is further configured to:
receive a first indication of a location of a first network node that configures the pattern of the set of CRSs; and
receive a second indication that the first network node is co-located with respect to a second network node associated with the set of CRSs,
wherein, to perform the set of measurements for the RF sensing session, the at least one processor is configured to:
perform the set of measurements for the RF sensing session based on the at least one CRS, the first indication, and the second indication.

11. The apparatus of claim 1, wherein the at least one processor is further configured to:
receive an indication of a location of a first network node that configures the pattern of the set of CRSs,
wherein, to perform the set of measurements for the RF sensing session, the at least one processor is configured to:
perform the set of measurements for the RF sensing session based on the least one CRS and the indication.

12. The apparatus of claim 1, wherein the at least one processor is further configured to:
transmit a sensing measurement report that is based on the set of measurements, wherein the sensing measurement report indicates a subset of the set of CRSs utilized for the set of measurements.

13. The apparatus of claim 1, wherein, to obtain the indication of the pattern of the set of CRSs, the at least one processor is configured to:
receive, from a network node, the indication of the pattern of the set of CRS; or
retrieve, from a first memory or a cache, the indication of the pattern of the set of CRS.

14. An apparatus of wireless communication at a first network node, comprising:
a memory; and
at least one processor coupled to the memory and, based at least in part on information stored in the memory, the at least one processor is configured to:
provide, for a first user equipment (UE), an indication of a pattern of a set of cell-specific reference signals (CRSs);
provide, for the first UE, at least one CRS in the set of CRSs based on the pattern of the set of CRSs; and
receive, from the first UE based on the at least one CRS, a sensing measurement report comprising a first set of measurements for a radio frequency (RF) sensing session.

15. The apparatus of claim 14, wherein the at least one processor is further configured to:
provide, for the first UE, at least one wideband reference signal, wherein the first set of measurements for the RF sensing session is further based on the at least one wideband reference signal, wherein the at least one CRS has a quasi-co-location (QCL) type C relationship with the at least one wideband reference signal.

16. (canceled)

17. The apparatus of claim 14, wherein the at least one processor is further configured to:
provide at least one of:
an expected value of a Doppler frequency shift with respect to a search window;
an expected uncertainty value of the Doppler frequency shift; or
for the first UE, assistance data for the RF sensing session, wherein the assistance data comprises at least one of:
a location of the first network node;
a boresight direction of a beam of a second UE that provides a Doppler estimation based on the set of CRSs;
an indication as to whether the first UE is to bypass an analysis of a Doppler measurement report associated with the second UE;
a first indication of a location of a second network node that configures the pattern of the set of CRSs; or
a second indication that the first network node is co-located with respect to the second network node,
wherein the first set of measurements for the RF sensing session is based on the assistance data.

18-21. (canceled)

22. The apparatus of claim 14, wherein the sensing measurement report indicates a subset of the set of CRSs utilized to generate the sensing measurement report.

23. The apparatus of claim 14, wherein the at least one processor is further configured to:
receive, from a second network node, a configuration for the pattern of the set of CRSs.

24. The apparatus of claim 23, wherein the first network node is co-located with respect to the second network node, wherein the at least one processor is further configured to:
perform a second set of measurements for a multiple-input multiple-output (MIMO) sensing session based on at least one of:
the at least one CRS; or
at least one wideband signal.

25. (canceled)

26. The apparatus of claim 23, wherein the first network node is not co-located with respect to the second network node, wherein the at least one processor is further configured to:
perform a second set of measurements for a multiple-input multiple-output (MIMO) sensing session based on the at least one CRS.

27. (canceled)

28. A method of wireless communication at a first user equipment (UE), comprising:
obtaining an indication of a pattern of a set of cell-specific reference signals (CRSs);
receiving at least one CRS in the set of CRSs based on the pattern of the set of CRSs; and
performing, based on the at least one CRS, a set of measurements for a radio frequency (RF) sensing session.

29-30. (canceled)
